(19) United States
(12) Patent Application Publication
(10) Pub. No.: US 2006/0271367 A1
(43) Pub. Date: Nov. 30, 2006

(54) Pitch pattern generation method and its apparatus

(75) Inventors: Go Hirabayashi, Kanagawa (JP); Takehiko Kagoshima, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/233,021

(22) Filed: Sep. 23, 2005

(30) Foreign Application Priority Data
May 24, 2005 (JP) 2005-151568

(51) Int. Cl. G10L 13/00

(52) U.S. Cl. 704/261

(57) ABSTRACT

A pitch pattern generation method which enables generation of a stable pitch pattern with high naturalness is provided, a pattern selection part 10 selects N pitch patterns 101 and M pitch patterns 103 for each prosody control unit from pitch patterns stored in a pitch pattern storage part 14 based on language attribute information 100 obtained by analyzing a text and phoneme duration 111, a pattern shape generation part 11 fuses the N selected pitch patterns 101 based on the language attribute information 100 to generate a fused pitch pattern and performs expansion or contraction of the fused pitch pattern in a time axis direction in accordance with the phoneme duration 111 to generate a new pitch pattern 102, an offset control part 12 calculates a statistic amount of offset values from the M selected pitch patterns 103 and deforms the pitch pattern 102 in accordance with the statistic amount to output a pitch pattern 104, and a pattern connection part 13 connects the pitch pattern 104 generated for each prosody control unit, performs a process of smoothing so that discontinuity does not occur at a connection boundary portion, and outputs a sentence pattern 121.

### CROSS-REFERENCE TO RELATED APPLICATIONS

This application is based upon and claims the benefit of priority from the prior Japanese Patent Application No. 2005-151568, filed on May 24, 2005; the entire contents of which are incorporated herein by reference.

### TECHNICAL FIELD

The present invention relates to a speech synthesis method for, for example, text-to-speech synthesis and an apparatus, and particularly to a pitch pattern generation method having a large influence on the naturalness of a synthesized speech and its apparatus.

### BACKGROUND OF THE INVENTION

In recent years, a text-to-speech synthesis system for artificially generating speech signals from an arbitrary sentence has been developed. In general, the text-to-speech synthesis system includes three modules, that is, a language processing part, a prosody generation part, and a speech signal generation part. Among these, the performance of the prosody generation part relates to the naturalness of the synthesized speech, and especially a pitch pattern as a change pattern of height (pitch) of a voice has a great influence on the naturalness of a synthesized speech. In a pitch pattern generation method of a conventional text-to-speech synthesis, since a pitch pattern is generated by using a relatively simple model, the intonation is unnatural and a mechanical synthesized speech is generated.

In order to solve such a problem, a method has been proposed in which a large number of pitch patterns extracted from natural speech are used as they are (see, for example, JP-A-2002-297175). This is such that pitch patterns extracted from natural speech are stored in a pitch pattern database, and one optimum pitch pattern is selected from the pitch pattern database according to attribute information corresponding to an input text so that a pitch pattern is generated.

Besides, a method has also been considered in which a pattern shape of a pitch pattern and an offset indicating the height of the whole pitch pattern are separately controlled (see, for example, ONKOURON 1-P-10, 2001.10). This is such that separately from the pattern shape of a pitch pattern, an offset value indicating the height of the pitch pattern is estimated by using a statistic model such as the quantification method type I generated off-line, and the height of the pitch pattern is determined based on this estimated offset value.

In the method in which the pitch pattern selected from the pitch pattern database is used as it is, since the pattern shape of the pitch pattern and the offset indicating the height of the whole pattern are not separated from each other, there is a possibility that the selection is limited to only such a pitch pattern that the whole height is unnatural although the pattern shape is suitable, or on the contrary, the pattern shape is unnatural although the whole height is suitable, and there is a problem that due to an insufficiency of variations in the pitch patterns, the naturalness of the synthesized speech is degraded.

On the other hand, in the method in which the offset value is estimated by using the statistic model separately from the pattern shape, since the estimate standard (evaluation criterion) for the offset value and the pitch pattern are different from each other, there is a problem that an unnatural pitch pattern is generated due to a mismatch between the estimated offset value and the pattern shape. Besides, since the statistic model such as the quantification method type I generated off-line in advance is used, as compared with the pattern shape selected on-line, it is difficult to estimate offset values corresponding to variations of various input texts, and as a result, there is a possibility that the naturalness of the generated pitch pattern becomes insufficient.

Then, in view of the above, the invention has an object to provide a pitch pattern generation method which can generate a stable pitch pattern with high naturalness by generating an offset value with high affinity to a pattern shape, and its apparatus.

### BRIEF SUMMARY OF THE INVENTION

According to embodiments of the present invention, a pitch pattern generation method which changes the original pitch pattern of a prosody control unit used for speech synthesis and generates the new pitch pattern using voice synthesis, includes the operations of storing offset values which indicate the height of pitch pattern of respective prosody control unit extracted from natural speech, storing first attribute information which has been made to correspond to the offset values in a memory, obtaining second attribute information by analyzing the text for which speech synthesis is to be done, selecting plural offset values for each prosody control unit from the memory based on the first attribute information and the second attribute information, obtaining a statistical profile of the plural offset values, and changing the pitch pattern, which is the prototype for each prosody control unit, based on the statistical profile.

Further, according to embodiments of the invention, a pitch pattern generation method includes storing first pitch patterns extracted from natural speech and first attribute information which has been made to correspond to the first pitch patterns into a memory, obtaining second attribute information by analyzing the text for which speech synthesis is to be done, selecting the plural first pitch patterns for each prosody control unit from the memory based on the first attribute information and the second attribute information, obtaining a statistic profile of offset values indicating heights of the first pitch patterns based on the plural first pitch patterns, generating a second pitch pattern of the prosody control unit based on the statistic profile of the offset values, and generating pitch patterns corresponding to the text by connecting the second pitch pattern of the prosody control unit.

### BRIEF DESCRIPTION OF THE DRAWINGS

FIG. 1 is a block diagram showing a structure of a text-to-speech synthesis system according to an embodiment of the invention.

FIG. 2 is a block diagram showing a structural example of a pitch pattern generation part.

FIG. 3 is a view showing a storage example of pitch patterns stored in a pitch pattern storage part.

FIG. 4 is a flowchart showing an example of a process procedure in the pitch pattern generation part.

FIG. 5 is a flowchart showing an example of a process procedure of a pattern selection part.

FIG. 6 is a flowchart showing an example of a process procedure of a pattern shape formation part.

FIGS. 7A and 7B are views for explaining a method of process to make lengths of plural pitch patterns uniform.

FIG. 8 is a view for explaining a method of process to generate a new pitch pattern by fusing plural pitch patterns.

FIG. 9 is a view for explaining a method of expansion or contraction process of a pitch pattern in a time axis direction.

FIG. 10 is a flowchart showing an example of a process procedure in an offset control part.

FIG. 11 is a view for explaining a method of process of the offset control part.

FIG. 12 is a block diagram showing a structural example of a pitch pattern generation part according to modified example 11.

FIG. 13 is a block diagram showing a structural example of a pitch pattern generation part according to another example of modified example 11.

### DETAILED DESCRIPTION OF THE INVENTION

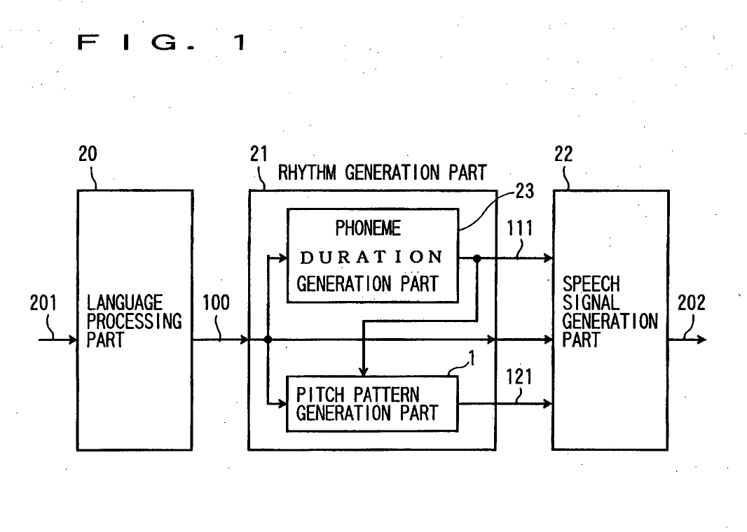

Hereinafter, an embodiment of the invention will be described in detail with reference to FIGS. 1 to 11.

### (1) Explanation of Terms

First, terms used in the embodiment will be described.

An ┌offset value┘ means information indicating the height of the whole pitch pattern corresponding to a prosody control unit as a unit for control of a prosodic feature of speech, and is information of, for example, an average value of pitch in the pattern, a center value, a maximum/minimum value, a change amount from the preceding or subsequent pattern.

A ┌prosody control unit┘ is a unit for control of a prosodic feature of speech corresponding to an input text, and includes, for example, a half phoneme, a phoneme, a syllable, a morpheme, a word, an accent phrase, a breath group and the like, and these may be mixed so that its length is variable.

┌Language attribute information┘ is information which can be extracted from an input text by performing a language analysis process such as a morpheme analysis or a syntactic analysis, and is information of, for example, a phonemic symbol line, a part of speech, an accent type, a modification destination, a pause, a position in a sentence and the like.

A ┌statistic amount of offset values┘ is a statistic amount calculated from plural selected offset values, and is, for example, an average value, a center value, a weighted sum (weighted additional value), a variance value, a deviation value or the like.

┌Pattern attribute information┘ is a set of attributes relating to the pitch pattern, and includes, for example, an accent type, the number of syllables, a position in a sentence, an accent phoneme kind, a preceding accent type, a subsequent accent type, a preceding boundary condition, a subsequent boundary condition and the like.

### (2) Structure of Text-to-Speech Synthesis System

FIG. 1 shows a structural example of a text-to-speech synthesis system according to the embodiment, and roughly includes three modules, that is, a language processing part 20, a prosody generation part 21, and a speech signal generation part 22.

An inputted text 201 is first subjected to language processing such as morpheme analysis or syntactic analysis in the language processing part 20, and language attribute information 100, such as a phonemic symbol line, an accent type, a part of speech, a position in a sentence or the like is outputted.

Next, in the prosody generation part 21, information indicating a prosodic feature of speech corresponding to the inputted text 201, that is, for example, a phoneme duration, a pattern indicating the change of a fundamental frequency (pitch) with the lapse of time, and the like are generated. The prosody generation part 21 includes a phoneme duration generation part 23 and a pitch pattern generation part 1. The phoneme duration generation part 23 refers to the language attribute information 100, generates a phoneme duration 111 of each phoneme, and outputs it. A pitch pattern generation part 1 receives the language attribute information 100 and the phoneme duration 111, and outputs a pitch pattern 121 as a change pattern of height of a voice.

Finally, the speech signal generation part 22 synthesizes speech corresponding to the inputted text 201 based on the prosody information generated in the prosody generation part 21, and synthesizes it as the speech signal 202.

### (3) Structure of the Pitch Pattern Generation Part 1

This embodiment is characterized in the structure of the pitch pattern generation part 1 and its process operation, and hereinafter, these will be described. Incidentally, here, a description will be made while a case where a prosody control unit is an accent phrase is used as an example.

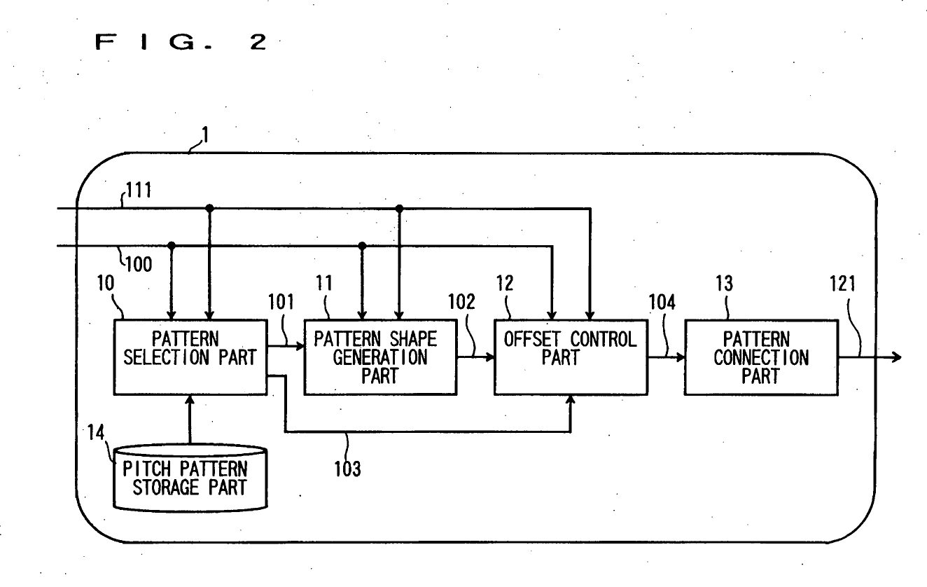

FIG. 2 shows a structural example of the pitch pattern generation part 1 of FIG. 1, and in FIG. 2, the pitch pattern generation part 1 includes a pattern selection part 10, a pattern shape generation part 11, an offset control part 12, a pattern connection part 13, and a pitch pattern storage part 14.

### (3-1) Pitch Pattern Storage Part 14

A large number of pitch patterns for each accent phrase extracted from natural speech, together with pattern attribute information corresponding to each pitch pattern, are stored in the pitch pattern storage part 14.

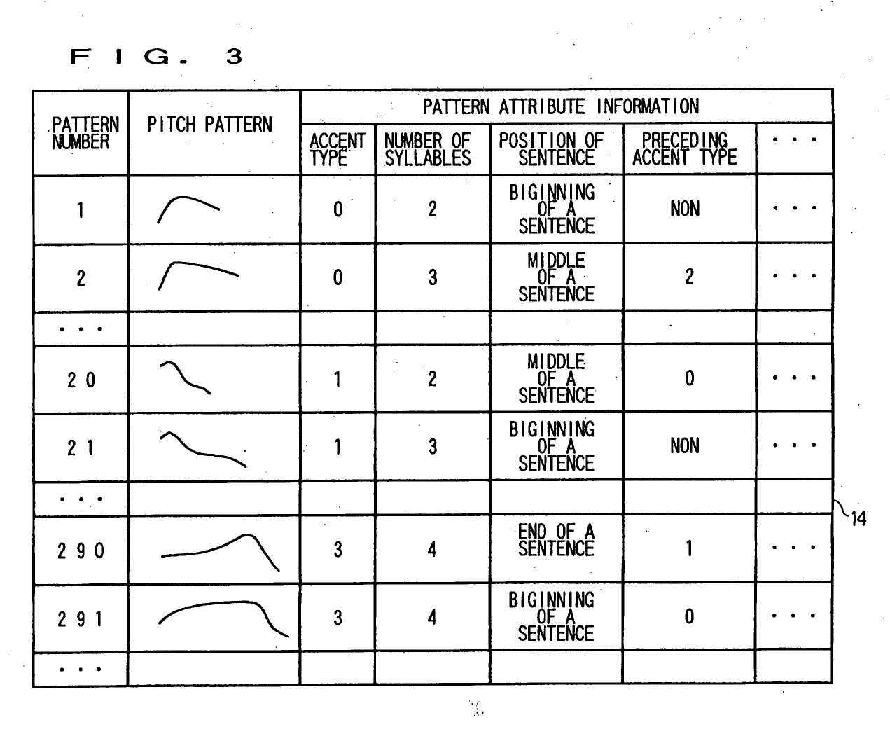

FIG. 3 is a view showing an example of information stored in the pitch pattern storage part 14.

The pitch pattern is a pitch series expressing the time change of the pitch (fundamental frequency) corresponding to the accent phrase or a parameter series expressing its feature. Although the pitch does not exist in a unvoiced portion, it is desirable to form a continuous series by, for example, interpolating a value of pitch of a voiced portion.

Incidentally, the pitch pattern extracted from natural speech may be stored as the quantization or approximated information, for example, obtained by vector quantization using a previously generated codebook.

### (3-2) Pattern Selection Part 10

The pattern selection part 10 selects N pitch patterns 101 and M pitch patterns 103 for each accent phrase based on the language attribute information 100 and the phoneme duration 111 from the pitch patterns stored in the pitch pattern storage part 14 (M>=N>1)

### (3-3) Pattern Shape Generation Part 11

The pattern shape generation part 11 generates a fused pitch pattern by fusing the N pitch patterns 101 selected by the pattern selection part 10 based on the language attribute information 100, and further performs expansion or contraction of the fused pitch pattern in a time axis direction in accordance with the phoneme duration 111, and generates a pitch pattern 102.

Here, the fusion of the pitch patterns means an operation to generate a new pitch pattern from plural pitch patterns in accordance with some rule, and is realized by, for example, a weighting addition process of plural pitch patterns.

### (3-4) Offset Control Part 12

The offset control part 12 calculates a statistic amount of offset values from the M pitch patterns 103 selected by the pattern selection part 10, and translates the pitch pattern 102 on a frequency axis in accordance with the statistic amount, and outputs a pitch pattern 104.

### (3-5) Pattern Connection Part 13

The pattern connection part 13 connects the pitch pattern 104 generated for each accent phrase, performs a process of smoothing to prevent discontinuity from occurring at the connection boundary portion, and outputs a sentence pitch pattern 121.

### (4) Process of the Pitch Pattern Generation Part 1

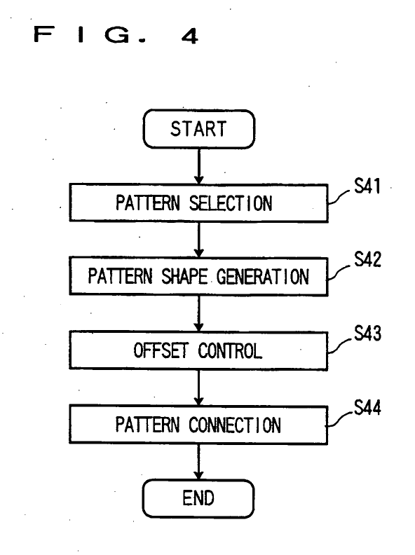

Next, the respective processes of the pitch pattern generation part 1 will be described in detail with reference to a flowchart of FIG. 4 showing the flow of a process in the pitch pattern generation part 1.

### (4-1) Pattern Selection

First, at step S41, based on the language attribute information 100 and the phoneme duration 111, the pattern selection part 10 selects the N pitch patterns 101 and the M pitch patterns 103 for each accent phrase from the pitch patterns stored in the pitch pattern storage part 14.

The N pitch patterns 101 and the M pitch patterns 103 selected for each accent phrase are pitch patterns in which the pattern attribute information is coincident to or similar to the language attribute information 100 corresponding to the accent phrase. This is realized, for example, in such a manner that a cost obtained by quantifying the degree of a difference of each pitch pattern to a target pitch change is estimated from the language attribute information 100 of the target accent phrase and each pattern attribute information, and a pitch pattern in which this cost is as small as possible is selected. Here, as an example, from pitch patterns in which the pattern attribute information is coincident with the accent type and the number of syllables of the target accent phrase, the M and the N pitch patterns with small costs are selected.

### (4-1-1) Estimation of Cost

The estimation of the cost is executed by calculating, for example, a cost function similar to one in a conventional speech synthesis apparatus. That is, for example, a sub-cost function C₁ (uᵢ, uᵢ₋₁, tᵢ) (l=1 to L, L denotes the number of sub-cost functions) is defined for each factor by which the pitch pattern shape or the offset varies, or for each factor of distortion produced when the pitch pattern is deformed/connected, and the weighted sum of these is defined as an accent phrase cost function.

$$C ( {u}_{i} , {u}_{i - 1} , {t}_{i} ) = {\sum }_{i = 1}^{L} {w}_{l} {C}_{l} ( {u}_{i} , {u}_{i - 1} , {t}_{i} ) \qquad ( 1 )$$

Where, tᵢ denotes target language attribute information of a pitch pattern of a portion corresponding to an i-th accent phrase when a target pitch pattern corresponding to an input text and language attribute information is t=(t₁, . . . , tₗ), and uᵢ denotes pattern attribute information of one pitch pattern selected from the pitch patterns stored in the pitch pattern storage part 14. Besides, w₁ denotes a weight of each sub-cost function.

The sub-cost function is for calculating the cost for estimation of the degree of the difference to the target pitch pattern in the case where the pitch pattern stored in the pitch pattern storage part 14 is used. In order to calculate the cost, here, as a specific example, two kinds (L=2) of sub-costs are set, that is, a target cost for estimation of the degree of the difference to the target pitch change produced by using the pitch pattern and a connection cost for estimation of the degree of the distortion produced when the pitch pattern of the accent phrase is connected to the pitch pattern of another accent phrase.

As an example of the target cost, a sub-cost function relating to a position in a sentence of the language attribute information and the pattern attribute information can be defined as indicated by a following expression.
C₁(uᵢ,uᵢ₋₁,tᵢ)=δ(f(uᵢ),f(tᵢ)) (2)

Where, f denotes a function to extract information relating to the position in the sentence from the pattern attribute information of the pitch pattern stored in the pitch pattern storage part 14 or the target language attribute information, and δ denotes a function which outputs 0 in the case where the two pieces of information are coincident with each other and outputs 1 in the other case.

Besides, as an example of the connection cost, a sub-cost function relating to a distinction (difference) of pitches at a connection boundary is defined as indicated by a following expression.
C₂(uᵢ,uᵢ₋₁,t₁)={g(uᵢ)−g(uᵢ₋₁)}² (3)

Where, g denotes a function to extract a pitch of the connection boundary from the pattern attribute information.

What is obtained by adding results of the accent phrase costs calculated from the expression (1) for the respective accent phrases of the input text with respect to all accent phrases is called a cost, and a cost function for calculating the cost is defined as indicated by a following expression.

$$Cost = {\sum }_{i = 1}^{I} C ( {u}_{i} , {u}_{i - 1} , {t}_{i} ) \qquad ( 4 )$$

By using the cost functions indicated by the expressions (1) to (4), plural pitch patterns for each accent phrase are selected from the pitch pattern storage part 14 through two stages.

### (4-1-2) Selection Process Through Two Stages

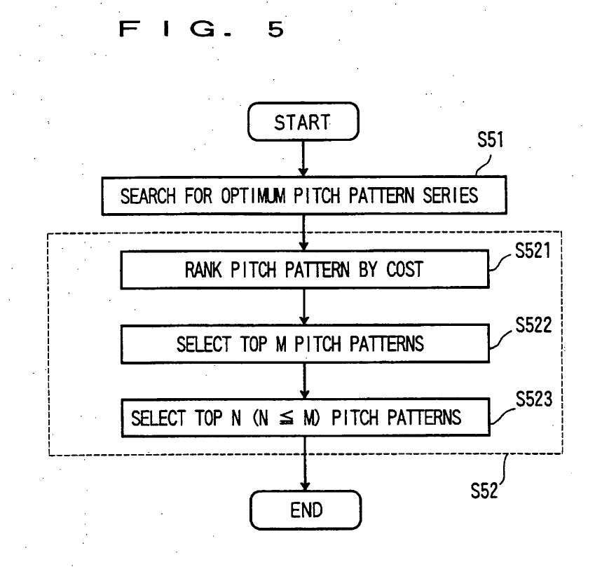

FIG. 5 is a flowchart for explaining an example of the selection process procedure through the two stages.

First, as a pitch pattern selection at the first stage, at step S51, a series of pitch patterns in which the cost value calculated by the expression (4) becomes minimum are obtained from the pitch pattern storage part 14. The combination of the pitch patterns in which the cost becomes minimum is called an optimum pitch pattern series. Incidentally, the search of the optimum pitch pattern series can be efficiently performed using the dynamic programming.

Next, advance is made to step S52, and at the second stage pitch pattern selection, plural pitch patterns are selected for each accent phrase by using the optimum pitch pattern series. Here, it is assumed that the number of accent phrases in the input text is I, and the M pitch patterns 103 for calculation of the statistic amount of the offset values and the N pitch patterns 101 for generation of the fused pitch pattern are selected for each accent phrase, and the details of step S52 will be described.

From step S521 to S523, one of the I accent phrases is made a target accent phrase. The process from step S521 to S523 is repeated I times, and the process is performed such that each of the I accent phrases becomes the target accent phrase once. First, at step S521, for the accent phrases other than the target accent phrase, the pitch pattern of the optimum pitch pattern series is fixed for each of them. In this state, with respect to the target accent phrase, the pitch patterns stored in the pitch pattern storage part 14 are ranked according to the value of the cost of the expression (4). Here, ranking is performed such that for example, a pitch pattern in which the value of the cost is lowest has a high rank. Next, at step S522, the top M pitch patterns for calculation of the statistic amount of the offset value are selected, and further, at step S523, the top N (N=<M) pitch patterns for generation of the fused pitch pattern are selected.

By the above procedure, with respect to each accent phrase, the M pitch patterns 101 and the N pitch patterns 103 are selected from the pitch pattern storage part 14, and next, advance is made to step S42.

(4-2) Pattern Shape Generation

At step S42, the pattern shape generation part 11 fuses the N pitch patterns 101 selected by the pattern selection part 10 based on the language attribute information 100 and generates the fused pitch pattern, and further performs expansion or contraction of the fused pitch pattern in the time axis direction in accordance with the phoneme duration 111 and generates the new pitch pattern 102.

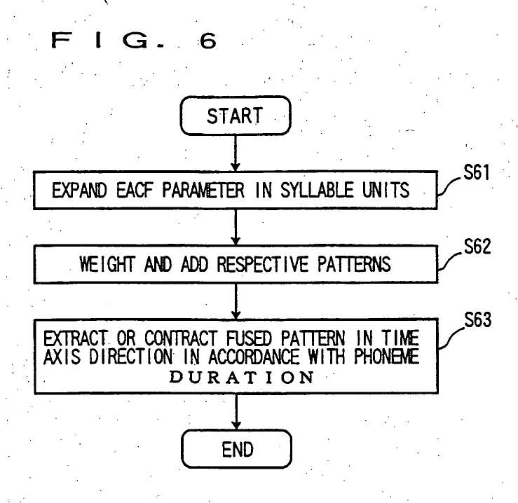

Here, an example of a process procedure in a case where with respect to one accent phrase of the plural accent phrases, the fusion of the N pitch patterns selected by the pattern selection part 10 and the expansion or contraction in the time axis direction are performed to generate the one new pitch pattern 102, will be described with reference to a flowchart of FIG. 6.

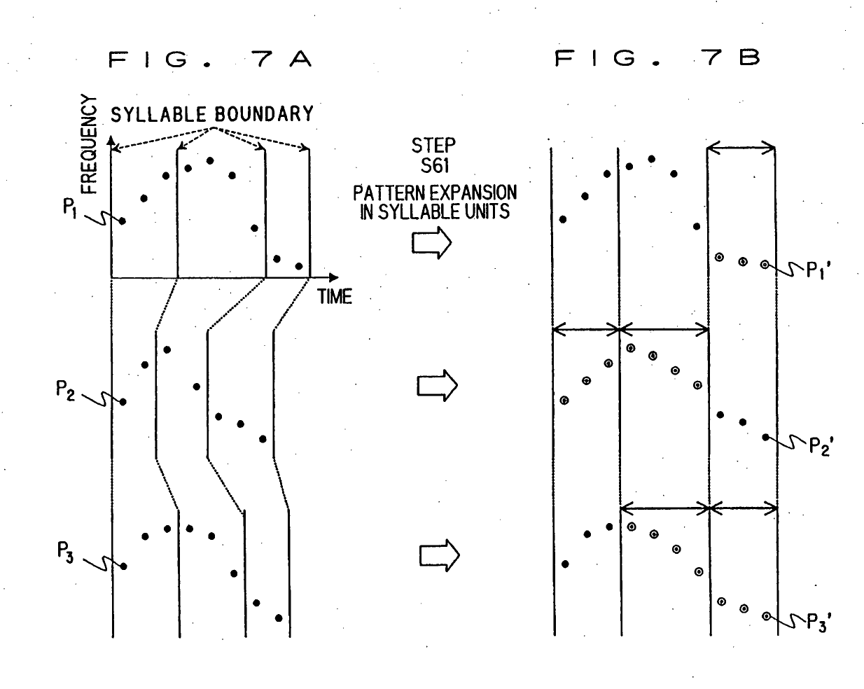

First, at step S61, the lengths of the respective syllables of the N pitch patterns are made uniform by expanding the pattern in the syllable so as to coincide with the longest in the N pitch patterns. FIGS. 7A and 7B show a state in which from each of N (for example, three) pitch patterns p₁ to p₃ (see FIG. 7A) of the accent phrase, pitch patterns p_{1′} to p_{3′} (see FIG. 7B) in which lengths of the patterns are made uniform with respect to the respective syllables are generated. In the example of FIGS. 7A and 7B, the expansion of the pattern in the syllable is performed by linear interpolation of data indicating one syllable (see portions of double circles of FIG. 7B).

Next, at step S62, a fused pitch pattern is generated by the weighting addition of the N pitch patterns in which the lengths are made uniform. The weight can be set according to, for example, similarity between the language attribute information 100 corresponding to the accent phrase and the pattern attribute information of each pitch pattern. Here, when consideration is made such that by using the reciprocal of the cost Cᵢ to each pitch pattern pᵢ calculated by the pattern selection part 10, a larger weight is given to a pitch pattern estimated to more suitable for a target pitch change, that is, a pattern with a small cost, a weight wᵢ to each pitch pattern pᵢ can be calculated by a following expression.

$${w}_{i} = \frac{1}{{C}_{i} \times {\sum }_{j = 1}^{N} \frac{1}{{C}_{j}}} \qquad ( 5 )$$

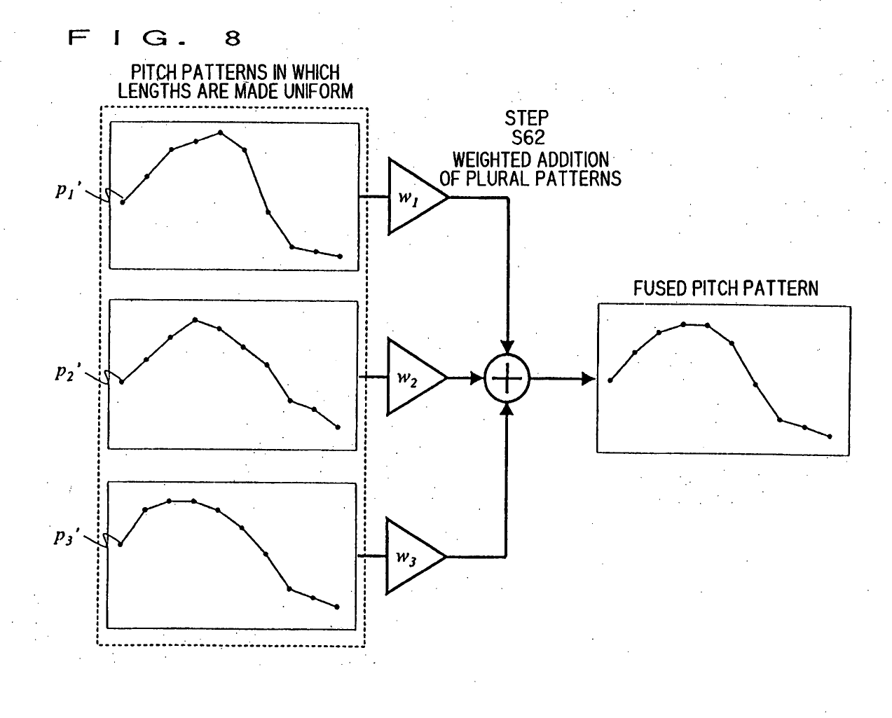

The fused pitch pattern is generated by multiplying each of the N pitch patterns by the weight and adding them. FIG. 8 shows a state in which the fused pitch pattern is generated by the weighting addition of the N (for example, three) pitch patterns of the accent phrase in which the lengths are made uniform.

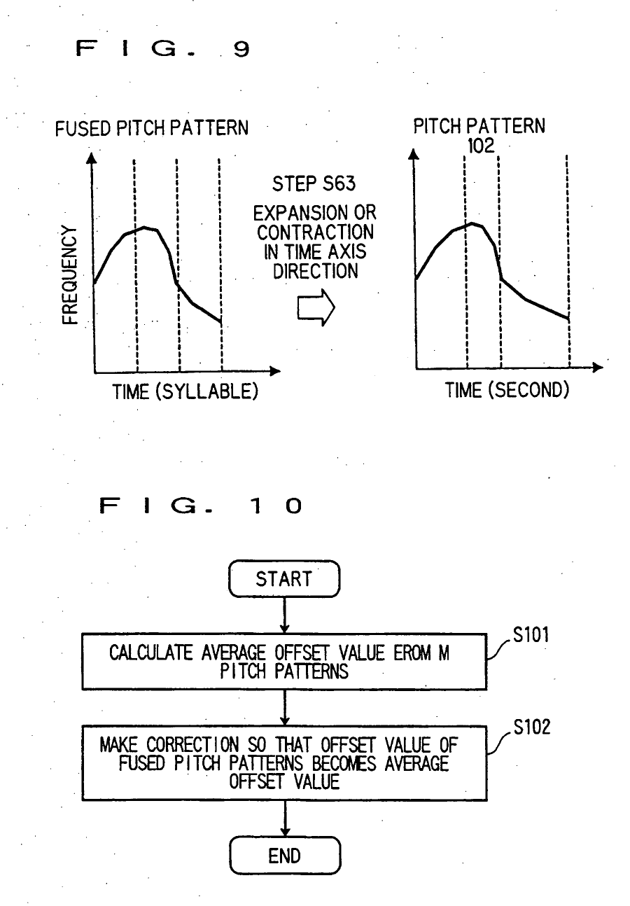

Next, at step S63, the fused pitch pattern is expanded or contracted in the time axis direction in accordance with the phoneme duration 111 to generate the new pitch pattern 102. FIG. 9 shows a state in which the lengths of the respective syllables of the fused pitch pattern are expanded or contracted in the time axis direction in accordance with the phoneme duration 111, and the pitch pattern 102 is generated.

As described above, with respect to each of the plural accent phrases corresponding to the input text, the N pitch patterns selected for the accent phrase are fused, and the expansion or contraction in the time axis direction is performed to generate the new pitch pattern 102, and next, advance is made to step S43.

### (4-3) Offset Control

At step S43, the offset control part 13 calculates a statistic amount of offset values from the M pitch patterns 103 selected by the pattern selection part 10, translates the pitch pattern 102 on the frequency axis in accordance with the statistic amount of the offset values, and generates the pitch pattern 104.

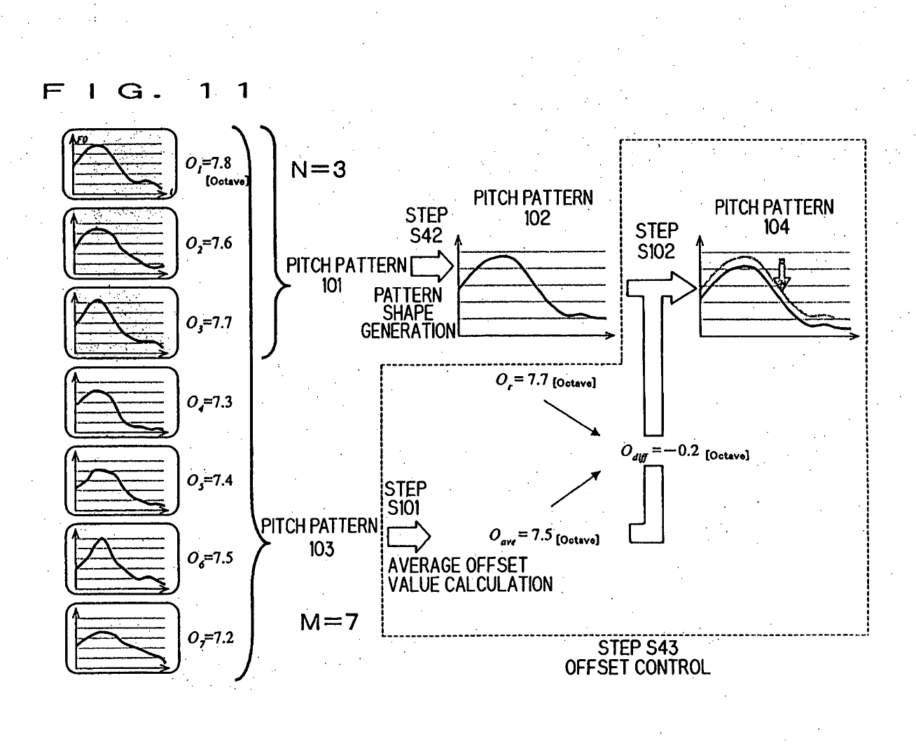

Here, as an example, a process procedure in a case where with respect to one accent phrase of the plural accent phrases, the pitch pattern 102 is translated on the frequency axis in accordance with an average value of offset values calculated from the M pitch patterns 103 selected by the pattern selection part 10 to generate the pitch pattern 104, will be described with reference to a flowchart of FIG. 10.

First, at step S101, an average offset value of the M selected pitch patterns is obtained. Average offset values Oᵢ of the respective pitch patterns are obtained by

$${O}_{i} = \frac{1}{{T}_{i}} {\sum }_{i = 1}^{{T}_{i}} {p}_{i} ( t ) \qquad ( 6 )$$

and an average value Oₐᵥₑ of the obtained average offset values Oᵢ(1=<i=<M) of the respective pitch patterns is obtained by

$${O}_{ave} = \frac{1}{M} {\sum }_{i = 1}^{M} {O}_{i} \qquad ( 7 )$$

and the average offset value of the M pitch patterns is obtained. Here, pᵢ(n) denotes a logarithmic fundamental frequency of an i-th pitch pattern, and Tᵢ denotes the number of samples thereof.

Next, at step S102, the pitch pattern is deformed so that the offset value of the pitch pattern 102 becomes the average offset value Oₐᵥₑ. An average offset value Oᵣ of the pitch pattern 102 is obtained by the expression (6), and a correction amount O_{diff} of the offset value is obtained by

[Mathematical Expression 8]
O_{diff}=Oₐᵥₑ−Oᵣ (8)
The pitch pattern 102 is translated on the frequency axis by adding the correction amount O_{diff} to the whole pitch pattern 102, and the pitch pattern 104 is generated.

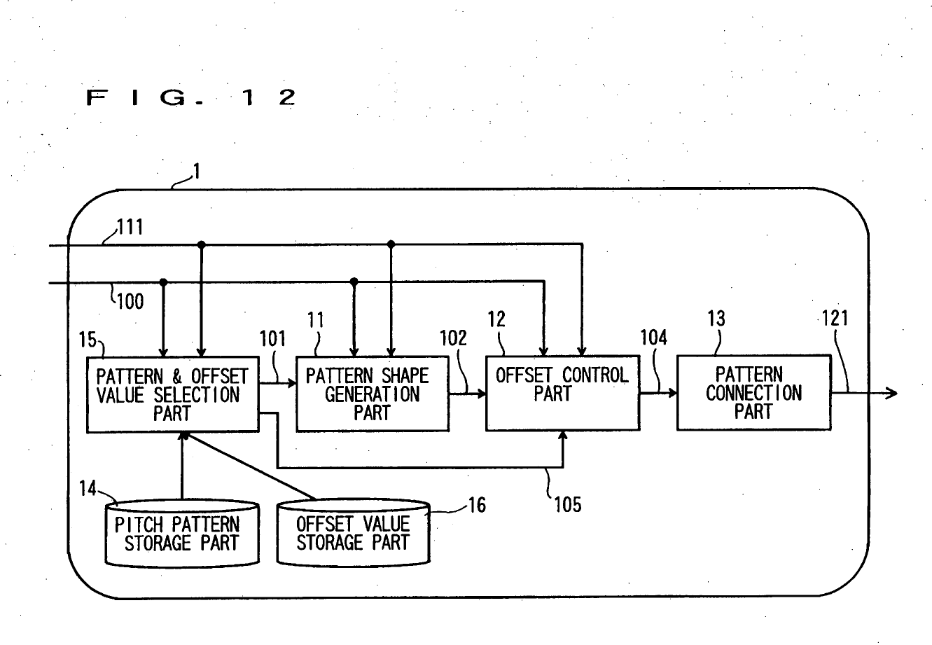

FIG. 11 shows an example of an offset control.

In this example, M=7, N=3, and O₁ to O₇ denote average offset values of the respective selected pitch patterns. The average offset value Oᵣ of the pitch pattern 102 generated at step S42 is 7.7 [Octave], the average offset value Oₐᵥₑ of the seven pitch patterns 103 is 7.5 [Octave], and the correction amount O_{diff} of the offset value becomes −0.2 [Octave]. The correction amount O_{diff} is added to the whole pitch pattern 102, so that the pitch pattern 104 in which the offset value is controlled is generated.

As described above, the pitch pattern 102 is translated on the frequency axis in accordance with the statistic amount of the offset values calculated from the M pitch patterns 103, and the pitch pattern 104 is generated, and next, advance is made to step S44 of FIG. 4.

### (4-4) Pattern Connection

At step S44, the pattern connection part 13 connects the pitch pattern 104 generated for each accent phrase, and generates the sentence pitch pattern 121 as one of prosodic features of the speech sound corresponding to the inputted text 201. When the pitch patterns 104 of the respective accent phrases are connected to each other, the process of smoothing or the like is performed so that discontinuity does not occur at the accent phrase boundary, and the sentence pitch pattern 121 is outputted.

### (5) Effect of the Embodiment

As described above, according to the embodiment, in the pattern selection part 10, based on the language attribute information 100 corresponding to the input text, the M and the N pitch patterns for each prosody control unit are selected from the pitch pattern storage part 14 in which a large number of pitch patterns extracted from natural speech are stored, and further, in the offset control part 12, the offset of the pitch pattern can be controlled based on the statistic amount of the offset values calculated from the M pitch patterns 103 selected for each prosody control unit.

Since the height of the whole pitch pattern is controlled in addition to the pattern shape, the dispersion of the height mismatch of the pitch pattern can be reduced without blunting the pattern shape excessively.

Since the pitch pattern 101 as the data for generation of the pattern shape and the pitch pattern 103 as the data for generation of the statistic amount of the offset values are selected by the pattern selection part 10 in accordance with the same standard (evaluation criterion), as compared with a method in which the offset value is singly estimated by a different method from the generation of the pattern shape, the offset control with high affinity with the pattern shape becomes possible.

Since the pitch patterns of various variations can be generated by selecting and using the pitch patterns extracted from natural speech on-line, the pitch pattern suitable for the input text and closer to the pitch change of a sound produced by a person can be generated, and as a result, a speech sound having high naturalness can be synthesized.

In the pattern selection part 10, even in the case where an optimum pitch pattern can not be uniquely selected, the pitch pattern is modified by using the statistic amount of the offset values obtained from plural suitable pitch patterns, so that a more stable pitch pattern can be generated.

### MODIFIED EXAMPLE 1

In the embodiment, at step S101 of FIG. 10, the weight used when the pitch patterns are fused is defined as the function of the cost value, however, no limitation is made to this.

For example, a method is conceivable in which a centroid is obtained with respect to plural pitch patterns 101 selected by the pattern selection part 10, and the weight is determined according to the distance between the centroid and each pitch pattern.

Also by this, even in the case where a bad pattern is suddenly mixed in the selected pitch patterns, generation of a pitch pattern in which the bad influence is suppressed can be performed.

Besides, also the example in which the uniform weight is applied for the whole prosody control unit has been described, however, the invention is not limited to this, and it is also possible to set different weights for the respective parts of the pitch patterns and to fuse them, for example, a weighting method is changed for only an accented portion.

### MODIFIED EXAMPLE 2

Modified example 2 of the embodiment will be described.

In the embodiment, at pattern selection step S41 of FIG. 4, the M and the N pitch patterns are selected for each prosody control unit, however, no limitation is made to this.

The number of patterns selected for each prosody control unit can be changed, and it is also possible to adaptively determine the number of selected patterns according to some factor such as the cost value or the number of pitch patterns stored in the pitch pattern storage part 14.

Besides, although the selection has been made from the pitch patterns in which the pattern attribute information is coincident with the accent type and the number of syllables of the accent phrase, the invention is not limited to this, and in the case where there is no coincident pitch pattern in the pitch pattern database, or there are few pitch patterns, the selection can also be made from candidates of similar pitch patterns.

Further, in the case of N=1, that is, the pattern shape can also be generated from the one optimum pitch pattern 101. In this case, the fusing process of the pitch patterns 101 at step S61 and S62 of FIG. 6 becomes unnecessary.

### MODIFIED EXAMPLE 3

Modified example 3 of the embodiment will be described.

In the embodiment, although the example is shown in which the information relating to the position in the sentence among the attribute information is used as the target cost in the pattern selection part 10, no limitation is made to this.

For example, other various information differences included in the attribute information are converted into numbers and may be used, or a distinction (difference) between each phoneme duration of a pitch pattern and a target phoneme duration may be used.

### MODIFIED EXAMPLE 4

Modified example 4 of the embodiment will be described.

Although the embodiment shows the example in which the difference between the pitches at the connection boundary is used as the connection cost in the pattern selection part 10, no limitation is made to this.

For example, a distinction (difference) between tilts of the pitch change at the connection boundary or the like can be used.

Besides, in the embodiment, as the cost function in the pattern selection part 10, the sum of the prosody control unit costs as the weighted sum of the sub-cost functions is used, however, the invention is not limited to this, and any function may be used as long as the sub-cost function is used as an argument.

### MODIFIED EXAMPLE 5

Modified example 5 of the embodiment will be described.

In the embodiment, as the estimation method of the cost in the pattern selection part 10, one in which the execution is made by calculating the cost function has been used as an example, however, no limitation is made to this.

For example, it is also possible to make an estimate by using a well-known statistic method such as the quantification method type I from the language attribute information and the pattern attribute information.

### MODIFIED EXAMPLE 6

Modified example 6 of the embodiment will be described.

In the embodiment, at step S61 of FIG. 6, when the lengths of the plural selected pitch patterns 101 are made uniform, the pattern is expanded in conformity with the longest among the pitch patterns for each the syllable, however, no limitation is made to this.

For example, by combination with the process of step S63, the respective pitch patterns can also be made uniform in accordance with the phoneme duration 111 and in conformity with the length actually needed.

Besides, the pitch patterns of the pitch pattern storage part 14 can be stored after the length of each syllable or the like is normalized in advance.

### MODIFIED EXAMPLE 7

Modified example 7 of the embodiment will be described.

In the embodiment, the pattern shape is first generated, and the offset is controlled, however, this process procedure is not limited to this.

For example, by exchanging the order of the processes of step S42 and step S43, first, the average offset value Oₐᵥₑ is calculated from the M pitch patterns 103, the respective offset values of the N pitch patterns 101 are controlled (pattern is deformed) based on the average offset value Oₐᵥₑ, and then, the N deformed pitch patterns are fused, and the pitch pattern for each prosody control unit can also be generated.

### MODIFIED EXAMPLE 8

Modified example 8 of the embodiment will be described.

In the embodiment, at step S43 of FIG. 4, the statistic amount of the offset values is made the average offset value Oₐᵥₑ calculated in accordance with the expression (7) from the respective offset values of the M pitch patterns 103, however, no limitation is made to this.

For example, the center value of the offset values of the M pitch patterns 103 or what is obtained by weighting and adding the respective offset values of the M pitch patterns with using the weight wᵢ based on the cost value of each pattern as obtained by the expression (5) may be used.

Besides, a pitch pattern in which the M pitch patterns 103 are fused is generated, and a shift amount for offset control can also be obtained based on such a standard that an error between the fused pattern and the pitch pattern 102 is made minimum.

### MODIFIED EXAMPLE 9

Modified example 9 of the embodiment will be described.

In the embodiment, at step S102 of FIG. 10, although the deformation of the pitch pattern based on the statistic amount of the offset values is made the translation of the whole pitch pattern on the frequency axis, no limitation is made to this.

For example, the pitch pattern is multiplied by a coefficient based on the statistic amount of the offset values to change the dynamic range of the pitch pattern, and the offset can also be controlled.

### MODIFIED EXAMPLE 10

Modified example 10 of the embodiment will be described.

In the embodiment, at step S62 of FIG. 6, although the weight at the time of fusing of the pitch patterns is defined as the function of the cost values, no limitation is made to this.

For example, a method is conceivable in which the fusion weight is determined by the statistic amount of offset values calculated from the M pitch patterns 103. In this case, first, an average μ and a dispersion σ² of offset values of the M pitch patterns 103 are obtained.

Then, a likelihood p(Oᵢ|μ, σ²) of each offset value Oᵢ of the N pitch patterns 101 used for the fusion of the patterns is obtained. For example, on the assumption that the Gaussian distribution is established, the likelihood can be obtained by a following expression.

$$p ( {O}_{i} \vert μ , {σ}^{2} ) = \frac{1}{\sqrt{2 π} σ} exp ( - \frac{{( {O}_{i} - μ )}^{2}}{2 {σ}^{2}} ) \qquad ( 9 )$$

The likelihood p(Oᵢ|μ, σ²) obtained by the expression (9) is normalized by a following expression and is made the weight at the time of the fusion.

$${w}_{i} = \frac{p ( {O}_{i} \vert μ , {σ}^{2} )}{{\sum }_{j = 1}^{N} p ( {O}_{j} \vert μ , {σ}^{2} )} \qquad ( 10 )$$

This weight wᵢ becomes larger as the respective offset values of the N pitch patterns becomes closer to the average of the distribution obtained from the offset values of the M pitch patterns, and becomes smaller as it goes away from the average. Thus, among the N pitch patterns to be fused, the fusion weight of the pattern in which the offset value goes away from the average value can be made small, and it is possible to reduce the fluctuation of the height of the whole pitch pattern due to the fusion of the patterns in which the offset values are greatly different and the degradation of naturalness.

### MODIFIED EXAMPLE 11

Modified example 11 of the embodiment will be described.

In the embodiment, in order to calculate the statistic amount of the offset values, at step S522 of FIG. 5, the pitch patterns are selected from the pitch pattern storage part 14, and at step S101 of FIG. 10, the average offset value is calculated from the M selected pitch patterns 103.

Instead of this, a structure can be adopted such that offset values of the respective pitch patterns are previously obtained off-line, and plural offset values are selected from an offset storage part storing these and are used for the offset control.

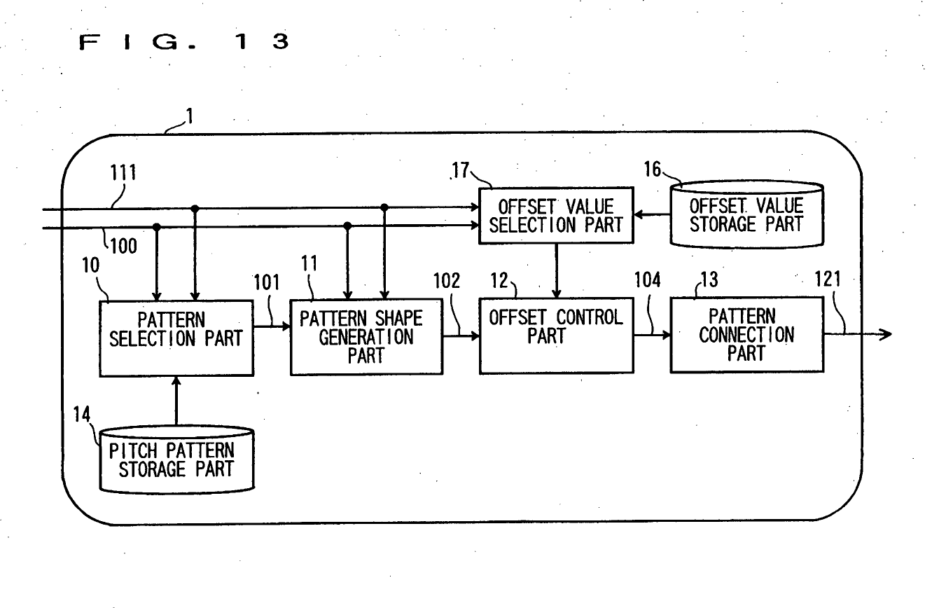

For example, as shown in FIG. 12, a structure may be such that in addition to a pitch pattern storage part 14 storing pitch patterns for each accent phrase together with attribute information corresponding to each pitch pattern, an offset value storage part 16 storing offset values for each accent phrase together with the corresponding attribute information is provided. In this structure, a pattern & offset value selection part 15 selects N pitch patterns 101 and M offset values 105 from the pitch pattern storage part 14 and the offset value storage part 16, respectively, and an offset control part 12 deforms a pitch pattern 102 based on a statistic amount of the M selected offset values 105.

Besides, as shown in FIG. 13, a structure can also be made such that a pitch pattern selection part 10 and an offset value selection part 17 are separated from each other. As stated above, when the offset control is performed based on an statistic amount of plural offset values selected on-line from the offset value storage part, pitch patterns having natural offset values corresponding to variations of various input texts can be generated.

### MODIFIED EXAMPLE 12

The functions of the respective embodiments can also be realized by hardware.

Besides, the method disclosed in the embodiment can be stored as a program, which can be executed by a computer, in a recording medium such as a magnetic disk, an optic disk, or a semiconductor memory, or can also be distributed through a network.

Further, the respective functions are described as software, and can also be realized by being processed by a computer apparatus having a suitable mechanism.

Incidentally, the invention is not limited to just the embodiments, and at a practical stage, the structural elements are modified within the scope not departing from the gist and can be embodied. Besides, various inventions can be formed by suitable combinations of plural structural elements disclosed in the embodiments. For example, some structural elements may be deleted from all structural elements disclosed in the embodiment. Further, structural elements in different embodiments may be suitably combined.

What is claimed is:

1. A pitch pattern generation method for generating a pitch pattern used for speech synthesis by changing the original pitch pattern of a prosody control unit, comprising:
storing offset values indicating heights of pitch patterns of respective prosody control units which have been extracted from natural speech and first attribute information which has been made to correspond to the offset values into a memory;
obtaining second attribute information by analyzing the text for which speech synthesis is to be done;
selecting plural offset values for each prosody control unit from the memory based on the first attribute information and the second attribute information;
obtaining a statistic profile of the plural offset values; and
changing the original pitch pattern of the prosody control unit based on the statistic profile.

2. A pitch pattern generation method comprising:
storing first pitch patterns extracted from natural speech and first attribute information which has been made to correspond to the first pitch patterns into a memory;
obtaining second attribute information by analyzing the text for which speech synthesis is to be done;
selecting plural first pitch patterns for each prosody control unit from the memory based on the first attribute information and the second attribute information;
obtaining a statistic profile of offset values indicating heights of the first pitch patterns based on the plural first pitch patterns;
generating a second pitch pattern of the prosody control unit based on the statistic profile of the offset values; and
generating a pitch pattern corresponding to the text by connecting the second pitch pattern of the prosody control unit.

3. A pitch pattern generation method according to claim 2, wherein
when the plural first pitch patterns are selected from the memory, M first pitch patterns and N (M≧N>1) first pitch patterns are respectively selected, and
when the second pitch pattern is generated,
(1) the statistic profile of the offset values is obtained from the M first pitch patterns,
(2) a fused pitch pattern is generated by fusing the N first pitch patterns, and
(3) the second pitch pattern is generated by changing the fused pitch pattern based on the statistic profile of the offset values.

4. A pitch pattern generation method according to claim 2, wherein
when the plural first pitch patterns are selected, M first pitch patterns and N (M≧N>1) first pitch patterns are respectively selected, and
when the second pitch pattern is generated,
(1) the statistic profile of the offset values is obtained from the M first pitch patterns,
(2) the N first pitch patterns are changed based on the statistic profile of the offset values, and
(3) the second pitch pattern is generated by fusing the N changed first pitch patterns.

5. A pitch pattern generation method according to claim 2, wherein
when the plural first pitch patterns are selected, M first pitch patterns and one first pitch pattern are respectively selected, and
when the second pitch pattern is to be generated,
(1) the statistic profile of the offset values is obtained from the M first pitch patterns, and
(2) the second pitch pattern is generated by changing one selected first pitch pattern based on the statistic profile of the offset values.

6. A pitch pattern generation method according to any one of claims 1 to 5, wherein the statistic profile of the offset values comprises the average value, median value and a weighted sum.

7. A pitch pattern generation method according to claim 2, wherein
when the plural first pitch patterns are to be selected, M first pitch patterns and N (M≧N>1) first pitch patterns are respectively selected, and
when the second pitch pattern is to be generated,
(1) the statistic profile of the offset values is obtained from the M first pitch patterns,
(2) the weight to be given to the respective N first pitch patterns is determined based on the respective offset values of the N first pitch patterns and the statistic profile, and
(3) the second pitch pattern is generated by fusing the N first pitch patterns based on the weights.

8. A pitch pattern generation method according to claim 1, wherein in the memory, the offset values indicating the heights of the pitch patterns extracted from natural speech are stored or quantized values of the extracted offset values are stored.

9. A pitch pattern generation method according to claim 2, wherein in the memory, the first pitch patterns extracted from the natural speech are stored, quantized values of the first pitch patterns are stored, or approximations of the first pitch patterns are stored.

10. A pitch pattern generation method according to claim 2, wherein in a case where the plural first pitch patterns are selected,
(1) the cost is estimated using a cost function from the first attribute information and the second attribute information, and
(2) the plural first pitch patterns in which the cost is small are selected.

11. A pitch pattern generation apparatus for generating a pitch pattern used for speech synthesis by changing the original pitch pattern of a prosody control unit, comprising:
a memory storing offset values indicating heights of pitch patterns of respective prosody control units which have been extracted from natural speech, and first attribute information which has been made to correspond to the offset values;
a second attribute information analysis processor unit that obtains second attribute information by analyzing the text for which speech synthesis is to be done;
an offset value selection processor unit that selects plural offset values for each prosody control unit from the memory based on the first attribute information and the second attribute information;
a statistic profile calculating unit that obtains a statistic profile of the plural offset values; and
a pitch pattern deformation processor unit that changes the original pitch pattern of the prosody control unit based on the statistic profile.

12. A pitch pattern generation apparatus, comprising:
a memory in which first pitch patterns extracted from natural speech and first attribute information which has been made to correspond to the first pitch patterns are stored;
a second attribute information analysis processor unit that obtains second attribute information by analyzing the text for which speech synthesis is to be done;
a first pitch pattern selection processor unit that selects plural first pitch patterns for each prosody control unit from the memory based on the first attribute information and the second attribute information;
a statistic profile calculating unit that obtains a statistic profile of offset values indicating heights of the first pitch patterns based on the plural first pitch patterns;
a second pitch pattern generation processor unit that generates a second pitch pattern of the prosody control unit based on the statistic profile; and
a pitch pattern generation processor unit that generates a pitch pattern corresponding to the text by connecting the second pitch pattern of the prosody control unit.

13. A pitch pattern generation program product for causing a computer to generate a pitch pattern used for speech synthesis by changing the original pitch pattern of a prosody control unit, the computer realizing:
a memory function storing offset values indicating heights of pitch patterns of respective prosody control units and which have been extracted from natural speech, and first attribute information which has been made to correspond to the offset values;
a second attribute information analysis function obtaining second attribute information by analyzing the text for which speech synthesis is to be done;
an offset value selection function selecting plural offset values for each prosody control unit from the memory, based on the first attribute information and the second attribute information;
a statistic profile calculation function obtaining a statistic profile of the plural offset values; and
a pitch pattern changing function changing the original pitch pattern of the prosody control unit based on the statistic profile.

14. A pitch pattern generation program product for causing a computer to realize:
a memory function storing first pitch patterns extracted from natural speech and first attribute information which has been made to correspond to the first pitch patterns;
a second attribute information analysis function obtaining second attribute information by analyzing the text for which speech synthesis is to be done;
a first pitch pattern selection function selecting the plural first pitch patterns for each prosody control unit from the memory based on the first attribute information and the second attribute information;
a statistic profile calculation function obtaining a statistic profile of offset values indicating heights of the first pitch patterns based on the plural first pitch patterns;
a second pitch pattern generation function generating a second pitch pattern of the prosody control unit based on the statistic profile; and
a pitch pattern generation function of generating a pitch pattern corresponding to the text by connecting the second pitch pattern of the prosody control unit.
